(19) United States
(12) Patent Application Publication
(10) Pub. No.: US 2014/0021065 A1
(43) Pub. Date: Jan. 23, 2014

(54) DEVICE AND METHOD FOR MEASURING BIOMARKERS

(71) Applicants: Justyna Wiedemair, Vienna (AT); Wouter Olthuis, Enschede (NL); Albert Van Den Berg, Nijverdal (NL)

(72) Inventors: Justyna Wiedemair, Vienna (AT); Wouter Olthuis, Enschede (NL); Albert Van Den Berg, Nijverdal (NL)

(73) Assignee: SENZAIR B.V., Enschede (NL)

(21) Appl. No.: 13/988,091

(22) PCT Filed: Nov. 18, 2011
(86) PCT No.: PCT/NL11/50788

§ 371 Date: Oct. 4, 2013

(30) Foreign Application Priority Data
Nov. 18, 2010 (NL) 2005714

(51) Int. Cl. G01N 27/404

(52) U.S. Cl. CPC G01N 27/4045
USPC 205/777.5; 204/403.06; 204/403.01; 205/785.5; 205/783

(57) ABSTRACT

The invention relates to a device for the measurement of hydrogen peroxide and optionally other biomarkers in a gaseous mixture, and in particular to a microfabricated device. The device comprises hydrogen peroxide capturing means and an electromechanical sensor comprising a sensing element in direct contact with the capturing means. The device further comprises means to measure the potential of the sensing element and/or the current through it as a result of a changing hydrogen peroxide concentration in the gaseous mixture. The device also comprises cooling/heating means for cooling and/or heating the capturing means. The device is preferably applied for online measurement of the hydrogen peroxide content in exhaled air.

The invention relates to a device for measuring hydrogen peroxide and optionally other biomarkers in a gaseous mixture, and in particular in exhaled air. The invention in particular relates to a microfabricated device for the on-line measurement of hydrogen peroxide and optionally other biomarkers, in a gaseous mixture, and in particular in exhaled air. The invention further relates to a method for measuring hydrogen peroxide and optionally other biomarkers, in a gaseous mixture using the device, and to the use of such device in measuring hydrogen peroxide and optionally other biomarkers in a gaseous mixture.

In the context of the present invention, a gaseous mixture is understood to mean any mixture of a gas and a liquid phase, including a gas only. The gaseous mixture may comprise one or more different species.

Detection of biomarkers, and hydrogen peroxide in particular, is relevant in a variety of life science applications. The measurement of hydrogen peroxide concentration in the breath of a person for instance can be important in many medical applications. Breath analysis of individuals affected by lung-related disorders such as chronic obstructive pulmonary disease (COPD) is of particular relevance, and hydrogen peroxide has been reported at elevated levels in exhaled breath condensate (EBC), see for instance Dekhuijzen, P. N., et al. Increased exhalation of hydrogen peroxide occurs in patients with stable and unstable chronic obstructive pulmonary disease. Am. J. Respir. Crit. Care. Med., 1996. 154(3 Pt 1): p. 813-816.

Typical hydrogen peroxide contents in exhaled air are low. Other gases are also present in the exhaled air in addition to hydrogen peroxide. Exhaled air thus comprises for instance CO₂ in volumes up to about 3 vol. % and O₂ in volumes up to 18 vol. %. The presence of these gases may make an accurate measurement of the relatively low hydrogen peroxide contents in the breath rather difficult.

Known measurement protocols for hydrogen peroxide encompass collection of EBC by condensation units, and subsequent off-line detection by a number of different techniques, including spectrophotometry, fluorimetric assays and chemiluminescence for instance. Although relevant levels of detection may be reached, such off-line protocols are generally time and labor intense, and may possibly lead to an extra source of inaccuracy in the obtained results.

The object of the present invention is to provide a device for measuring hydrogen peroxide, and optionally other biomarkers, in a gaseous mixture, in particular in exhaled air, which device is capable of point-of-care hydrogen peroxide detection in EBC leading to an improvement in monitoring and treatment of affected patients. There is further a need for a device for the measurement of hydrogen peroxide, and optionally other biomarkers, in a gaseous mixture which device does not take up much space and can be readily arranged on a patient.

This and other objectives are achieved by a device according to claim 1. In particular a device is provided for the measurement of hydrogen peroxide and optionally other biomarkers in a gaseous mixture, the device comprising hydrogen peroxide capturing means and an electrochemical sensor comprising a sensing element in direct contact with the capturing means, the device further comprising means to measure the potential of the sensing element and/or the current as a result of a changing hydrogen peroxide concentration in the gaseous mixture, as well as cooling/heating means for cooling and/or heating the capturing means. The device is particularly suitable for the on-line measurement of hydrogen peroxide and optionally other biomarkers in a gaseous mixture.

Particularly preferred is a device that comprises means to set the potential of the sensing element and measure the current as a result of a changing hydrogen peroxide concentration in the gaseous mixture. Providing such a device allows the accurate measurement of hydrogen peroxide concentration.

The invented device does not comprise many selective components, apart from the applied potential in the present embodiment. This means that the device is very versatile and may also be used for measuring other biomarkers in the gaseous mixture, in particular redox-active biomarkers. Under certain conditions, the device is not totally specific for hydrogen peroxide, which may actually be an advantage. Firstly, in case there are other electroactive biomarkers in a breath sample for instance, which other biomarkers reflect back on a disease state, the device may be used as an indicator for such a disease by measuring the total redox-activity of the sample, for instance measured at a certain potential. Secondly, the device can actually be used for detecting other species besides hydrogen peroxide, which species are medically relevant for lung related disorders and the like. Such species should be detectable either directly or indirectly by electrochemistry. An indirect measurement involves a species which is not necessarily redox active by itself, but is converted, for instance by an enzyme, producing either immediately or in a reaction cascade a redox active analyte which then is measured at the electrode.

EBC comprises aerosolized airway lining fluid evolved from the airway wall by turbulent airflow that serves as seeds for substantial water vapor condensation, which then serves to trap water soluble volatile gases. The aerosolized part contributes the non-volatile constituents of EBC, including ions and proteins. The water soluble volatiles are incorporated into EBC through entirely different mechanisms than the non-volatiles, and therefore dilution issues become essentially irrelevant. However what is relevant for the volatile components is their volatility and water-partition coefficients, which in part are inherent characteristics, and in part depend on temperature and pH of the source fluid. EBC generally samples both volatiles and non-volatiles, and they must be recognized as separate (although occasionally overlapping) entities with different properties.

EBC generally contains every species that the airway lining fluid contains, but in very small concentrations. In an exhaled breath sample, hydrogen peroxide will generally be present in the liquid phase, but it may also be present in the gas phase of the breath. According to the invention, a device is provided comprising cooling/heating means for cooling or heating the capturing means. Such a device enhances EBC collection since the exhaled breath samples may better condense (upon cooling) or dissolve in a suitable solvent in the capturing means. Moreover this embodiment allows to regenerate the capturing means after hydrogen peroxide detection. Integrated cooling/heating means not only allow more water and hydrogen peroxide to condense in the capturing means, thereby enhancing selectivity, but also provide a more stable temperature within the device, which increases measurement accuracy. Although many heating/cooling means can be used in the device according to the invention, a preferred embodiment of the device has cooling/heating means comprising a Peltier element.

Another essential aspect of the invention includes the use of hydrogen peroxide capturing means. The capturing means hold a measurable quantity of hydrogen peroxide and are in direct contact with a sensing element of the electrochemical sensor. In order to perform the electrochemical detection of hydrogen peroxide, the capturing means preferably will have to be wet either by capturing the condensate by cooling, and/or by employing a hygroscopic material per se or by modification, and/or by using an external reservoir used for continuous wetting. In the preferred embodiment including a Peltier element, condensation of the hydrogen peroxide containing sample may be enhanced by cooling. According to the invention, the hydrogen peroxide uptake in the capturing means is actually measured electrochemically at the sensing element, which preferably comprises the working electrode of an electrochemical sensor, as described in more detail below. The capturing means inter alia allow to measure hydrogen peroxide in a gaseous mixture.

In a further preferred embodiment, the device according to the invention is characterized in that the capturing means comprise a membrane that covers the sensing element. The membrane is adapted to capture and hold hydrogen peroxide molecules for some time.

Preferred embodiments of the device according to the invention make use of a membrane that comprises a polymer, a hygroscopic polymer per se or by modification, and even more preferred a gel, a hydrogel, a stimulus responsive hydrogel and/or a xerogel (e.g. a silica based sol-gel). These materials moreover are apt to incorporate the preferred high water contents.

In another aspect of the invention a device is provided having a membrane comprising a microporous membrane. Alternatively, a micromachined array of channels in a solid material can also be used. In such embodiments, capillary forces draw the hydrogen peroxide containing EBC into the pores of the membrane.

In still another aspect of the invention, a device is provided in which the membrane comprises a hygroscopic additive such as but not limited to a salt. Another preferred option would be to use a hygroscopic additive such as glycerol. Also, the membrane may comprise pH control means, preferably a buffer solution.

Another preferred embodiment of the device according to the invention is characterized in that the pH control means comprise pH active groups incorporated in the membrane material. Examples of such pH active groups include but are not limited to carboxyl and/or amine groups.

A particularly simple and effective solution for controlling pH in the membrane is provided by an embodiment in which the device comprises a buffer reservoir. Such a reservoir is provided in contact with the membrane and contains a suitable electrolyte that is supplied to the membrane, preferably with a controlled flow and/or wicking action.

The device according to the invention may be used in a variety of applications in which the measurement of hydrogen peroxide is of importance. A particularly preferred use includes measuring the hydrogen peroxide content in the airflow exhaled by a person.

The invention provides for this purpose an EBC supply and conditioning unit. The unit comprises an inlet for the exhaled breath and an outlet for the measured EBC, between which the device for the, preferably on-line, measurement of hydrogen peroxide is arranged. The EBC supply and conditioning unit is provided with supply means for the exhaled air, preferably a flexible tube that connects to the capturing means of the hydrogen peroxide sensor. The inlet typically comprises a mouth piece or volume sensor to which the tube is attached. A flow of exhaled air is typically of an interrupted nature (during inhalation). Moreover, it is almost impossible for a person to exhale at a constant flow rate, so a considerable variation occurs around the average volume of say 500 ml per breath. The EBC supply and conditioning unit therefore preferably comprises a buffering and mixing chamber in which exhaled breath is collected and subsequently pumped to the hydrogen peroxide measuring device of the invention, preferably at a substantially constant flow rate. This embodiment of the EBC supply and conditioning unit comprises constant flow rate pump means for instance that ensure that a substantially constant flow rate of exhaled breath is fed to the hydrogen peroxide measuring device. The desired measuring flow rate can be adjusted in a simple manner. Pump means are per se known, also for micro- or macroelectronic devices, and suitable pump means comprise for instance an electromagnetic or membrane pump.

A preferred embodiment of the EBC supply and conditioning unit comprises heating means for at least the hydrogen peroxide supply means. Providing the device with such heating means reduces or even avoids condensation of the exhaled air. This improves the accurate measurement of hydrogen peroxide in EBC, since hydrogen peroxide is readily dissolved in water and preventing condensation therefore also prevents hydrogen peroxide loss. The device is preferably provided for this purpose with heating means in the form of a resistance wire connectable to a power source, although any heating means may in principle be used. Heating to a temperature at which condensation is substantially avoided is in principle already sufficient, wherein the precise temperature will depend, among other factors, on the temperature and the degree of humidity of the environment. It is however advantageous for the heating means to also comprise a temperature regulator. Using such a regulator the desired temperature of the device, or at least parts thereof, can be set to the predetermined, most suitable level. It has been found that in the case of a device for measuring the hydrogen peroxide content in exhaled air, wherein use is made of supply means in the form of a flexible tube, the most suitable temperature is a few degrees higher than the body temperature, preferably up to 10° C. higher, still more preferably up to 5° C. higher.

The invented device can be used to measure hydrogen peroxide in a gaseous mixture, preferably on-line. A method according to the invention comprises capturing hydrogen peroxide in capturing means, electrochemically converting the hydrogen peroxide in the gaseous mixture at a sensing element of an electrochemical sensor in direct contact with the capturing means, and measuring the potential of the sensing element and/or the current through it as a result of a changing hydrogen peroxide concentration in the gaseous mixture.

The invented device may be used for accurately measuring the hydrogen peroxide content in a gas mixture with or without using enzymes. Using the device without any enzymes may be advantageous since enzymes are not very stable generally and may for instance leak out of the capturing means, thus decreasing the response over time.

In a preferred embodiment of the method, the method includes setting the potential of the sensing element and measuring the current as a result of a changing hydrogen peroxide concentration in the gaseous mixture. The sensing element is typically an electrode as used in electrochemical sensors. Electrochemical sensors are particularly attractive due to low-cost and ease of miniaturization. After uptake and diffusion to the electrode surface, hydrogen peroxide is electrochemically converted resulting in a concentration dependent current signal. Hydrogen peroxide can be both oxidized and reduced at the electrode surface. Hydrogen peroxide is then detected by direct electrochemical conversion at this electrode, which preferably comprises a platinum electrode. Other possibilities comprise the use of Prussian Blue or enzymes for enhancement of selectivity/catalysis, possibly with another electrode material, and for “indirect” detection of hydrogen peroxide; the use of a platinized electrode surface, either platinum or other electrode material, for a possibly more efficient detection of hydrogen peroxide; the use of nano-/micro-particles for a possibly more efficient detection of hydrogen peroxide; and/or the use of other electrode materials.

In a preferred embodiment of the device, the device comprises a three-electrode setup containing a macroelectrode as a working electrode WE, a counter electrode CE, and a reference electrode RE, for instance a Ag/AgCl reference electrode RE, with a specific arrangement to each other. The device is fabricated by a specific protocol at a glass substrate. Other embodiments of the device use alternative chip/electrode geometries (i.e. a different size, shape, and arrangement with respect to each other, etc.). It is also possible to use a microelectrode, or a microelectrode array instead of a macroelectrode. Alternatively, one can use two working electrodes instead of one working electrode utilizing a different measurement technique, such as but not limited to redox cycling. In principle any manufacturing technique for (macro- or microfabricated) devices may be used according to the invention. It is for instance possible to use a different chip fabrication technique and/or a substrate material that differs from glass. It is also possible to use a two electrode setup instead of a three electrode setup. Also different types of reference electrode besides a Ag/AgCl reference electrode RE could be used.

In a preferred embodiment of the method, the capturing means are cooled and/or heated before, during or after measuring hydrogen peroxide. Cooling of the capturing means enhances condensation of the EBC captured therein, which may help in detecting hydrogen peroxide.

In another preferred embodiment of the method, the capturing means are heated after having measured the hydrogen peroxide. Such a heating step regenerates the capturing means to ready it (to ‘reset’ it) for another measurement.

Although any electrochemical method may be used, tests have shown that amperometry is most suitable for the accurate measurement of hydrogen peroxide. In such a preferred embodiment of the method, the current through the sensing element is measured at a constant potential.

It may also be advantageous to precondition the sensing element, preferably the electrode(s), and more preferable to precondition electrochemically.

In one embodiment of the invention, the working electrode WE is kept at a constant potential for a certain amount of time during preconditioning. Preferred constant potentials range from 0.4 to 0.6V versus the chip integrated Ag/AgCl reference electrode RE, preferably for times between 0 and 10 min. Preconditioning is preferably performed in the same solution as used for the actual measurement, for which measurement potentials preferably range between 0.4-0.6V, or even slightly lower than 0.4 V.

In another embodiment of the invention, a step sequence of different potentials is used instead of imposing a constant potential. A preferred method comprises a relatively short conditioning for an amount of time shorter than 10 min. at a relatively high potential, preferably higher than 0.6 V, and measuring H₂O₂ at a lower potential, preferably lower than 0.6 V, this sequence being carried out in a number of cycles.

Other preferred embodiments of the method comprise methods wherein the hydrogen peroxide is captured in a membrane that covers the sensing element; methods wherein a hygroscopic additive such as but not limited to a salt is added to the capturing means; methods wherein a pH control means, preferably an electrolyte solution is added to the capturing means; and/or methods wherein the sensing element is calibrated by measuring another electrochemically active species in the gaseous mixture, which concentration remains substantially constant, and wherein this concentration is used as a reference value.

The invention will now be elucidated on the basis of non-limitative exemplary embodiments shown in the following figures and description. Herein:

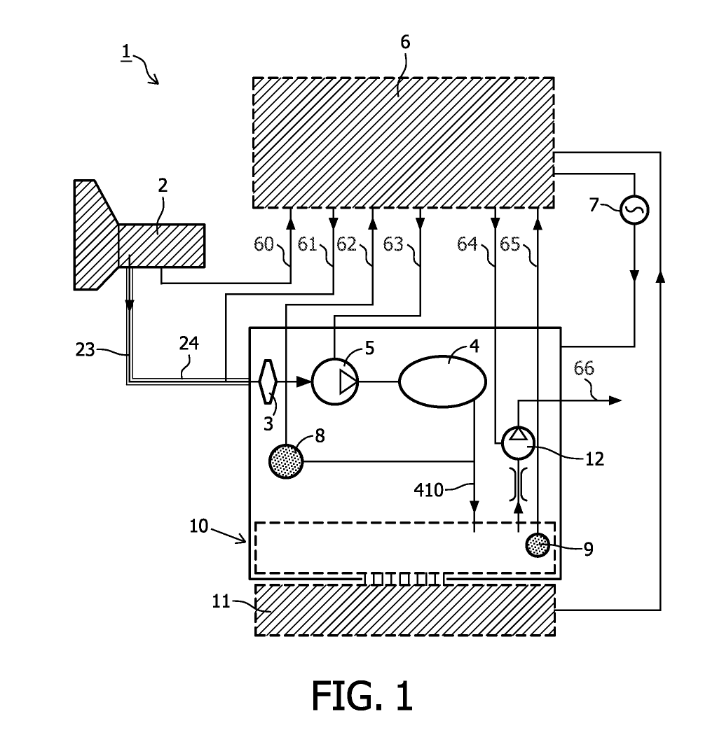

FIG. 1 schematically shows an exhaled air supply and conditioning unit comprising an embodiment of the hydrogen peroxide measuring device according to the invention;

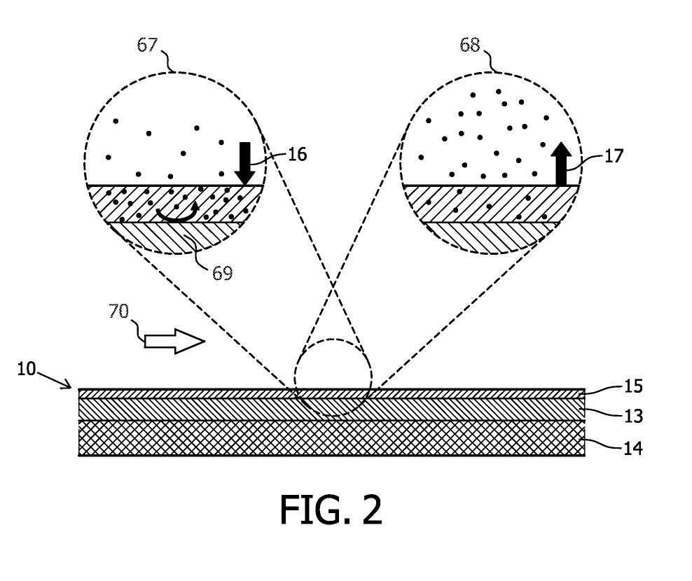

FIG. 2 schematically shows a side view of an embodiment of the hydrogen peroxide measuring device according to the invention;

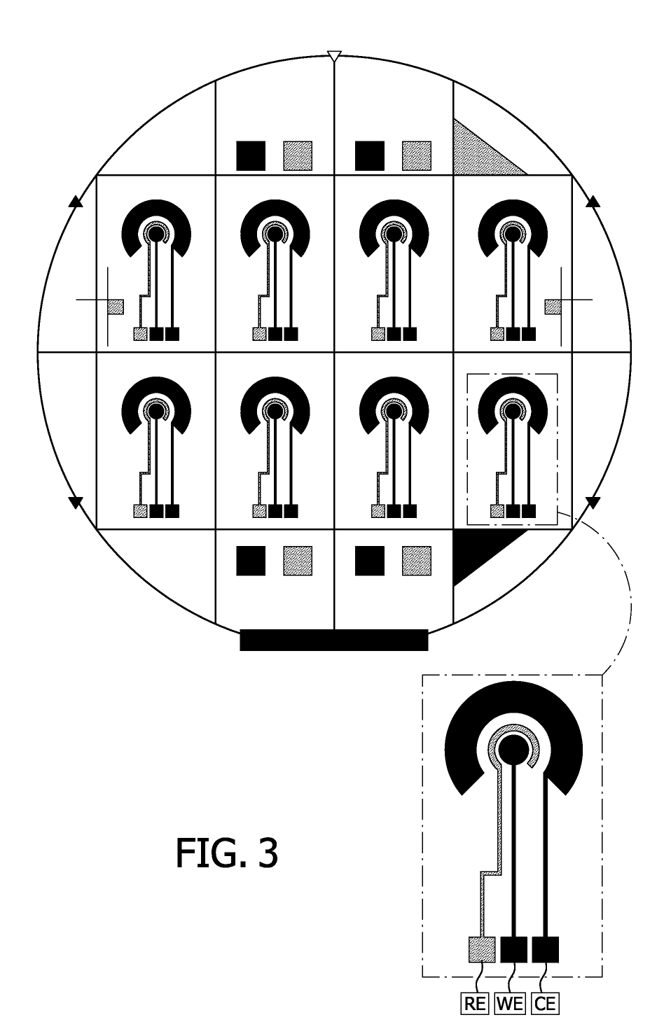

FIG. 3 schematically shows a mask design showing an embodiment of several electrochemical sensing elements according to the invention;

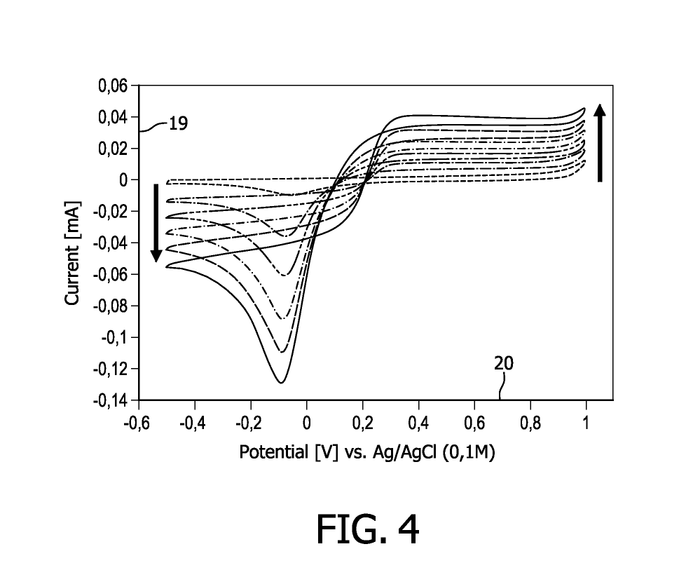

FIG. 4 shows cyclic voltammograms obtained with the hydrogen peroxide measuring device according to the invention;

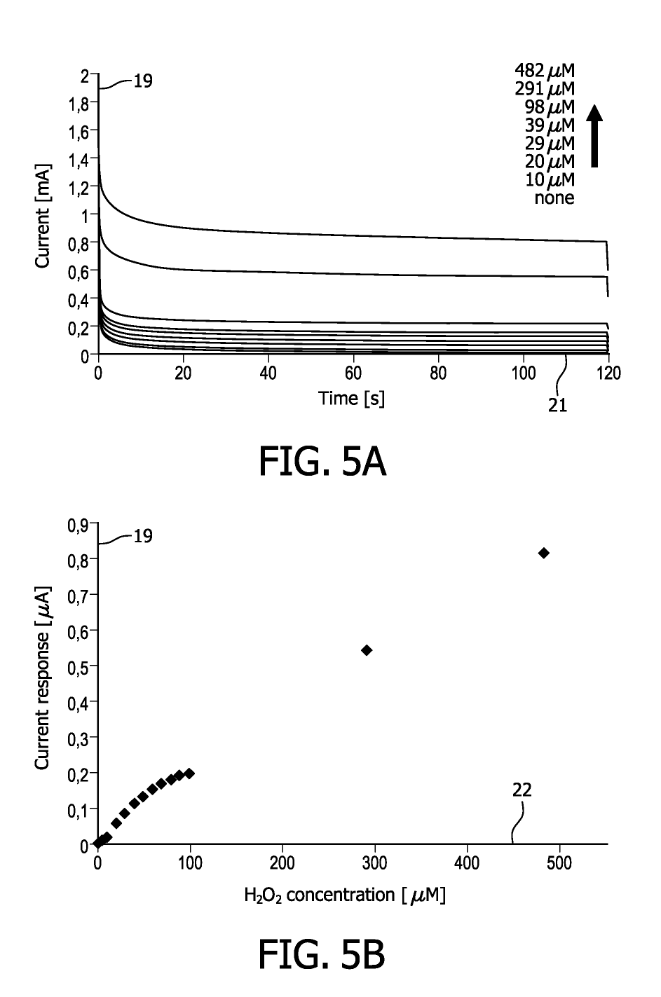

FIG. 5A schematically shows amperometric response curves obtained with the hydrogen peroxide measuring device according to the invention;

FIG. 5B schematically shows a calibration curve obtained from the amperometric response curves of FIG. 5A; and

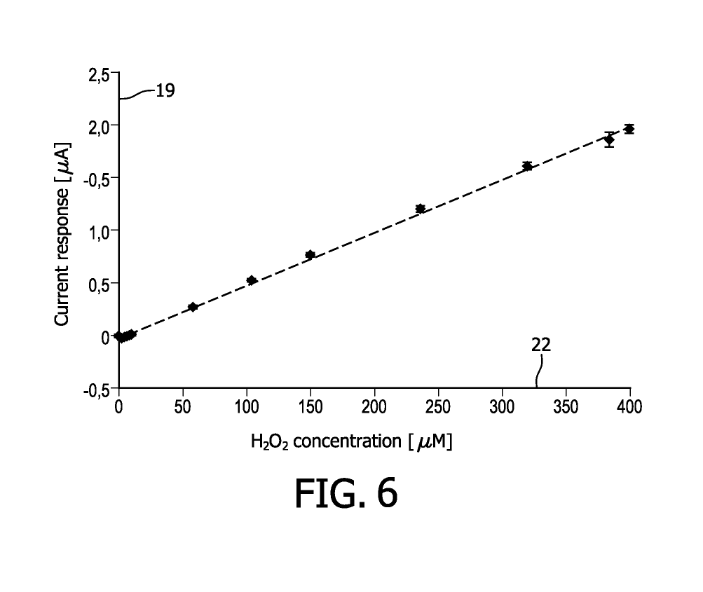

FIG. 6 schematically shows an averaged calibration curve obtained from the amperometric response curves recorded at a biased working electrode WE.

Referring to FIG. 1, an EBC supply and conditioning unit 1 comprising an embodiment of the hydrogen peroxide measuring device 10 according to the invention is shown as a non-limitative example. The unit 1 is typically used for collecting breath samples for breath analysis. A patient or other test person breathes through a volume sensor 2 and a proportional pump 5 sucks an exhaled gas sample via a filter 3 from the volume sensor 2 to a buffering and mixing chamber 4. The buffering and mixing chamber 4 is used to collect a sample volume that comprises a representative part of the EBC. The volume amount of breath sucked in varies in proportion to the amount of EBC as measured by the volume sensor 2. Such a proportional sampling ensures that a ‘weighted’ mean fraction of the EBC is provided. A ‘weighted’ mean fraction of the EBC allows to accurately determine the hydrogen peroxide concentration in the gas sample by a hydrogen peroxide measuring device 10 connected to the buffering and mixing chamber 4 through conduit 410. In FIG. 1, the numbers in the boxes have the following meaning:
60 volume
61 heater
62 pressure
63 pump
64 pump
65 temperature
66 exhaust

Condensation of moisture is preferably avoided in the sampling tube since hydrogen peroxide readily dissolves in water. To this end, the EBC supply and conditioning unit 1 is equipped with e.g. a resistance heater 7 to bring the gas sample to an elevated temperature which depends on the specific circumstances but may be at least 40° C. for instance. During transport of the gas sample through the flexible tube 23 that connects the volume sensor 2 and the filter 3, the gas sample is held at an elevated temperature by a heating element 24 provided around the tube 23.

The gas sample is preferably fed to and through the hydrogen peroxide measuring device 10 at a substantially constant flow rate, which is typically in the range of 20 to 100 ml/min, more preferably 35 to 65 ml/min. The buffering and mixing chamber 4 may thus have a variable volume since the in- and outgoing gas flows may be different. The mean amount of gas provided by the proportional pump preferably corresponds to the outgoing gas flow provided to the hydrogen peroxide measurement device 10. The ratio of the exhaled gas flow to the capacity of the proportional pump 5 therefore is adapted continuously in a preferred embodiment. For this reason, and for general control of the device, the EBC supply and conditioning unit 1 is controlled in operation by a measurement and control unit 6, which collects signals from measurement sensors such as volume sensor 2, pressure sensor 8 and temperature sensor 9, and provides the steering signals to the heater 24, to the proportional pump 5, and to a sample pump 12 which evacuates the gas stream after measurement by the hydrogen peroxide measurement device 10. The operation of the hydrogen peroxide measurement device 10 itself is controlled by a sensor control unit 11.

FIG. 2 shows a schematic of the proposed hydrogen peroxide sensor 10 and operational principle. As also illustrated by every chip unit in FIG. 3, the proposed sensor 10 consists of a glass-based micro-fabricated chip 13 containing three electrodes, a working electrode WE, a counter electrode CE, and a reference electrode RE. The chip 13 is covered with a gel-like membrane or polymer 15 and placed on a Peltier element 14 enabling cooling or heating of the chip 13 and membrane 14. The membrane 14 is kept wet for electrochemical detection of hydrogen peroxide either by employing a hygroscopic material per se or by adding a hygroscopic additive, and/or by an external reservoir (not shown) used for continuous wetting. By actuation of the Peltier element 14 by the sensor control unit 11, condensation of the hydrogen containing sample in the membrane 15 is enhanced. The sample is drawn in the membrane 15 during cooling of the device 10 with the aid of Peltier element 14, as schematically shown in FIG. 2 by arrow 16. Consequently hydrogen peroxide uptake in the membrane 15 will be measured electrochemically at the working electrode WE. If necessary, after hydrogen peroxide detection heating by means of the Peltier element 14 at least partially regenerates the membrane 15 by evaporation of moisture, as shown schematically in FIG. 2 by arrow 17. In FIG. 2, the numbers in the boxes have the following meaning:
67 cooling
68 heating
69 redox
70 sample flow

In the embodiment shown, the process utilized for chip fabrication was based on conventional lithography, metallization, and lift-off. Photolithographic masks were designed according to a software package, known per se. Several parameters, such as electrode sizes, shapes, and distances with respect to each other were considered for the mask design. In the design shown in FIG. 3 the working electrode WE has an area of about 4.9 mm², the counter electrode CE of about 54.4 mm² or 45.3 mm², and the reference electrode RE of about 4.1 mm² or 18.1 mm² (values for electrode areas calculated without considering contact lines). Note that although these designs have shown satisfying performance, other configurations may also be designed with similar or better performance. FIG. 3 shows an overlay of the two mask designs, wherein platinum features are shown in dark and silver features in lighter shade. As can be noted, two designs for electrode arrangements were incorporated.

To accommodate for the different electrode materials, two separate photolithographic and metallization steps were conducted. For each step lift-off resist and positive rest was spun on borofloat wafers, followed by exposure and development for structure definition. The following metallization was performed. The counter electrode CE and the working electrode WE were comprised of a layered structure of Ta (20 nm) and Pt (180 nm), and the reference electrode RE of Ti, Pd and Ag (total thickness about 560 nm). Ta or Ti was used as adhesion promotor, and Pd as diffusional barrier. Excess metal was removed by lift-off in acetone. Finally, the wafers were diced into individual chips of 2 cm×3 cm.

Initial tests have shown that amongst standard electrode materials such as platinum, gold, or glassy carbon, platinum was the best option for the detection of hydrogen peroxide with the working electrode WE. Thus all the data shown herein is based on platinum as a working electrode WE material. An electrochemical cell was fabricated allowing for fixed positioning of all electrodes with respect to each other, and controlled sample inlet.

Cyclic voltammograms (CVs) were used to determine the optimum working potential for the amperometric sensor. Several different electrolyte compositions were investigated, such as KCl, KNO₃, phosphate buffer, and KCl-phosphate buffer mixtures. Oxidation and reduction of hydrogen peroxide was observed in all CVs. All solutions were de-aerated in order to minimize interference of oxygen reduction. Since oxygen reduction may occur in the region of hydrogen peroxide reduction, it is preferred to use oxidation of hydrogen peroxide due to the final targeted application of an oxygen rich environment (breath). Oxidation of hydrogen peroxide in a phosphate-buffered environment occurs at a lower potential compared to CVs recorded in KCl or KNO₃ as supporting electrolytes. Since the goal is to achieve the lowest possible working potential, a phosphate-buffered system is preferred for the measurement of hydrogen peroxide with the device 10.

The CVs shown in FIG. 4 were conducted using a chloridized Ag layer as a reference electrode RE. Different levels of hydrogen peroxide (1-5 mM) were added to the solution with increasing amounts of hydrogen peroxide depicted by arrow 18. In order to stabilize the potential of the reference electrode RE, the optimized electrolyte preferably also contains CL ions, and a mixture of 0.1M phosphate buffer (KH₂PO₄/K₂HPO₄, pH7), and 0.1M KCl was chosen as a final composition for the supporting electrolyte. It is clear from the measurements that the current 19 presented in mA increases upon subsequent additions of hydrogen peroxide. An oxidation potential 20 between 0.4-0.5V (vs. the chip-integrated Ag/AgCl reference electrode RE) is preferably used for the oxidation of hydrogen peroxide, as shown in FIG. 4 for this particular embodiment of the device and method according to the invention.

An appropriate method of displaying the dependence of hydrogen peroxide concentration in the EBC samples and the measured current is by means of a calibration curve. To this end, amperometry was conducted at different working electrode WE potentials (E=0.4V, or E=0.5V vs. chip-integrated Ag/AgCl reference electrode RE). FIG. 5A shows representative current-time traces recorded while biasing the working electrode WE at E=0.4V vs. the chip-integrated Ag/AgCl reference electrode RE in solutions containing different levels of hydrogen peroxide. The current level 19 (presented in μA) increases with every addition of hydrogen peroxide, and a limit of detection in the range of 2 μM can be estimated. Averaging the current between 59s and 61s leads to the calibration curve plotted in the FIG. 5B of current 19 vs. hydrogen peroxide concentration 22. Note that the current response is normalized to the background (i.e. the background current level is subtracted from the current recorded at the respective hydrogen peroxide concentrations).

FIG. 6 shows an averaged calibration curve, obtained by repeating the calibration measurements described above 4 times at a potential of 0.5 V. It turns out that the amperometric device as described above and incorporating a Peltier element-based condensation unit 14 close to the electrode 13 interface in combination with a hygroscopic membrane 15 is able to measure hydrogen peroxide content.

1. Device for the measurement of hydrogen peroxide and optionally other biomarkers in a gaseous mixture, the device comprising hydrogen peroxide capturing means and an electrochemical sensor comprising a sensing element in direct contact with the capturing means, the device further comprising means to measure the potential of the sensing element and/or the current through it as a result of a changing hydrogen peroxide concentration in the gaseous mixture, as well as cooling/heating means for cooling and/or heating the capturing means.

2. Device according to claim 1, wherein the device further comprises means to set the potential of the sensing element and measure the current as a result of a changing hydrogen peroxide concentration in the gaseous mixture.

3. Device according to claim 1, wherein the cooling/heating means comprise a Peltier element.

4. Device according to claim 1, wherein the capturing means comprise a membrane that covers the sensing element.

5. Device according to claim 4, wherein the membrane comprises a polymer, a gel, a hydrogel, a stimulus responsive hydrogel and/or a xerogel.

6. Device according to claim 4, wherein the membrane comprises a microporous membrane.

7. Device according to claim 4, wherein the membrane comprises a hygroscopic additive.

8. Device according to claim 4, wherein the membrane comprises pH control means.

9. Device according to claim 8, wherein the pH control means comprise a buffered electrolyte solution.

10. Device according to claim 8, wherein the pH control means comprise pH active groups incorporated in the membrane material.

11. Device according to claim 4, wherein the membrane comprises a solid polymer electrolyte.

12. Device according to claim 1, wherein the device comprises a buffer reservoir.

13. Device according to claim 1, wherein the gaseous mixture comprises exhaled air, and the device is provided with supply means for the exhaled air that connect to the capturing means.

14. Device according to claim 13, wherein the supply means comprise a flexible tube that is provided with heating means.

15. Use of a device as claimed in claim 1 for measuring the hydrogen peroxide content in the airflow exhaled by a person.

16. Use as claimed in claim 15, wherein the person is subjected to physical exertion and the hydrogen peroxide content and optionally the content of other biomarkers is measured during this exertion.

17. Use of a device as claimed in claim 1 for measuring the hydrogen peroxide content in a gas mixture with or without using enzymes.

18. Method for the measurement of hydrogen peroxide and optionally other biomarkers in a gaseous mixture, the method comprising capturing hydrogen peroxide in capturing means, electrochemically converting the hydrogen peroxide in the gaseous mixture at a sensing element of an electrochemical sensor in direct contact with the capturing means, and measuring the potential of the sensing element and/or the current through it as a result of a changing hydrogen peroxide concentration in the gaseous mixture, whereby the capturing means are cooled and/or heated before, during or after measuring hydrogen peroxide.

19. Method according to claim 18, wherein the method comprises capturing hydrogen peroxide in capturing means, electrochemically converting the hydrogen peroxide in the gaseous mixture at a sensing element of an electrochemical sensor in direct contact with the capturing means, setting the potential of the sensing element and measuring the current as a result of a changing hydrogen peroxide concentration in the gaseous mixture.

20. Method according to claim 18, wherein the capturing means are heated after having measured the hydrogen peroxide.

21. Method according to claim 18, wherein the sensing element is preconditioned, preferably electrochemically.

22. Method according to claim 21, wherein preconditioning is carried out by holding a working electrode WE of the sensing element at a constant potential during a period of time between 0 and 10 min.

23. Method according to claim 21, wherein preconditioning is carried out by a step sequence of different potentials, comprising a conditioning for a period of time shorter than 10 min. at a first potential, and measuring H2O2 at a potential lower than the first potential, this sequence being carried out a number of cycles.

24. Method according to claim 21, wherein preconditioning is carried out in the same solution as used for the actual measurement.

25. Method according to claim 18, wherein the hydrogen peroxide is captured in a membrane that covers the sensing element.

26. Method according to claim 18, wherein to the capturing means is added a hygroscopic additive.

27. Method according to claim 18, wherein to the capturing means is added a pH control means, preferably a buffered electrolyte solution.

28. Method according to claim 18, wherein the sensing element is calibrated.

29. Method according to claim 28, wherein the sensing element is calibrated by measuring another electrochemically active species in the gaseous mixture, which concentration remains substantially constant, and use this concentration as a reference value.

30. Method according to claim 18, wherein the gaseous mixture comprises exhaled air and exhaled air is led to the capturing means on-line.
